(19) United States
(12) Patent Application Publication
(10) Pub. No.: US 2008/0276699 A1
(43) Pub. Date: Nov. 13, 2008

(54) Method For Automatically Initializing an Indirectly Measuring Tire Pressure Monitoring System

(75) Inventors: Frank Edling, Kanagawa (JP); Frank Schreiner, Friedrichsdorf (DE); Andreas Kobe, Bensheim (DE); Vladimir Koukes, Darmstadt (DE); Martin Griesser, Eschborn (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 12/064,036

(22) PCT Filed: Aug. 3, 2006
(86) PCT No.: PCT/EP2006/065055

§ 371 Date: Feb. 18, 2008

(30) Foreign Application Priority Data
Aug. 18, 2005 (DE) 10 2005 039 484.1
Jul. 12, 2006 (DE) 10 2006 032 212.6

(51) Int. Cl. G01M 17/02

(52) U.S. Cl. 73/146

(57) ABSTRACT

Method for automatically initializing an indirectly measuring tire pressure monitoring system which due a change of the rotational behavior of the vehicle wheels, in particular a change in the rolling circumference detects a deflation on the vehicle wheels by comparing learnt reference values with continuously detected new values (1), where furthermore a deflation on the vehicles wheels is detected by evaluating the natural frequency of the single vehicle wheels (3) and where an automatic initialization (5) is being executed, if the indirectly measuring tire pressure monitoring system during the movement of the vehicle after a standstill detects a deflation on a vehicle wheel compared with the situation before the standstill of the vehicle (2), whereas the evaluation of the natural frequency of the vehicle wheels does not detect a deflation on the same vehicle wheel (4).

The present invention relates to a method for automatically initializing an indirectly measuring tire pressure monitoring system according to the preamble of claim 1 as well as a computer program product according to claim 6.

In modern motor vehicles, systems are increasingly applied which contribute to an active or passive protection of the passengers. Systems for monitoring the tire pressure protect the passengers from vehicle damages which can e.g. be attributed to an abnormal tire inflation pressure. Said abnormal tire inflation pressure may e.g. increase the wear of the tire and the fuel consumption or a tire defect (burst tire) may occur. Several tire pressure monitoring systems are referenced which either work on the basis of directly measuring sensors or determine an abnormal wheel pressure by evaluating the wheel speed or vibration characteristics of the vehicle wheels.

DE 100 58 140 A1 discloses a so-called directly measuring tire pressure monitoring system which detects a drop in tire pressure by evaluating the rotational movements of the wheel (DDS: Deflation Detection System).

Patent application DE 10 2005 004 910 A1 discloses a method for indirectly monitoring the tire pressure which improves an indirectly measuring tire pressure monitoring system based on the evaluation of the rotational movement of the wheel, considering the torsion natural frequency of the tires. Said tire pressure monitoring systems is initialized when the driver activates a switch or a pushbutton. In case the initialization does not occur, a faulty warning has to be expected. For ease of use, it is also desirable that the system itself recognizes the necessity of an initialization and then executes it. Furthermore the costs for the pushbutton in the dashboard respectively the costs for developing the menu-driven initialization would be eliminated.

It is the object of the invention to improve the tire pressure monitoring system referenced in patent application DE 10 2005 004 910 A1 in such a way that the system is automatically initialized.

This object is achieved by means of the method according to claim 1.

The invention is based on the idea that the initialization is executed automatically if the indirectly measuring tire pressure monitoring system detects a deflation on the wheel by evaluating the rotational movements of the wheel after a standstill of the motor vehicle, whereas the natural frequency analysis of the tires does not detect a deflation on this wheel. On these conditions it is very likely that at least one tire has been changed or exchanged or that on at least one tire the air pressure has been adapted. In such cases the indirectly measuring tire pressure monitoring system should learn the new tires respectively the tire circumferences changed by the adaptation of the tire pressure, in order to avoid faulty warnings.

In this case it is preferred that the entire indirectly measuring tire pressure monitoring system is initialized automatically.

In a further preferred embodiment only one part of the indirectly measuring tire pressure monitoring system is initialized automatically. This may be the part basing on the evaluation of the rotational behavior of the vehicle wheels or also the part basing on the evaluation of the natural frequency of the vehicle wheels.

Furthermore it is preferred that the signatures of the wheel speed sensors on the vehicle wheels are used for determining whether or not to execute an automatic initialization.

An advantage of the method according to the present invention is that an initialization by the driver is no longer needed. Thus the risk is eliminated that the driver forgets the initialization and a faulty warning is emitted. Furthermore there is no need for a switch or a pushbutton on the dashboard or a menu navigation for starting the initialization by the driver.

Other preferred embodiments result from the subclaims and the following description of embodiments on the basis of a figure.

In the accompanying drawing:

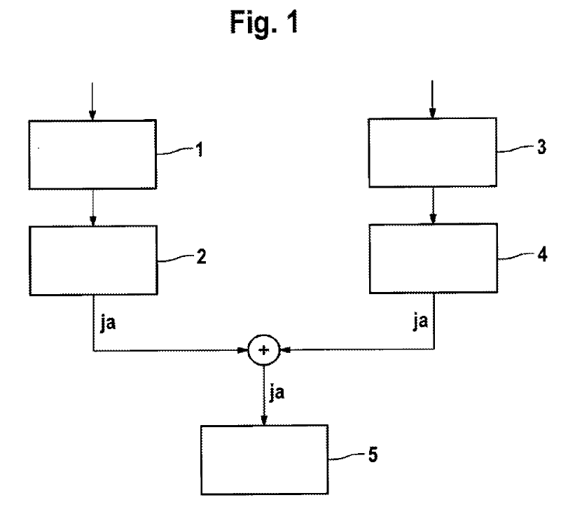

FIG. 1 is a flow chart of a method according to the invention automatically initializing an indirectly measuring tire pressure monitoring system.

The method for indirectly monitoring the tire pressure, referenced in patent claim DE 10 2005 004 910 A1 evaluates a change in the rolling circumferences and a change in the vibration characteristics (torsion natural frequency) of the wheels with regard to a tire deflation. In case of a deflated wheel, the rolling circumference of the wheel decreases due to the reduced tire pressure. If the rolling circumference or a proportional variable corresponding to the rolling circumference (also called reference value) falls below or exceeds a threshold value, a wheel deflation is detected and a warning emitted to the driver. The wheel characteristics (tread compound, summer/winter tires, tire size etc.) have a considerable effect on a pressure-dependent change of the rolling circumference of the wheels.

If within a certain period of time after starting the vehicle from the standstill the rolling circumferences measured by the indirectly measuring tire pressure monitoring system differ from the learnt value by more than a threshold value, this might have several causes:
a) the tire is deflated,
b) at least one tire was changed/exchanged or
c) the driver or a workshop has adapted the air pressure on at least one wheel.

In the case described in point a) the automatic initialization (auto reset) must not be executed, but a warning has to be emitted to the driver that a deflation has been detected. In the cases described in points b) and c) an automatic initialization (auto reset) has to be executed so that the indirectly measuring tire pressure monitoring system is able to learn the new states (new tire respectively different tire pressure).

If within a certain period of time after starting the vehicle from a standstill the rolling circumferences measured by the indirectly measuring tire pressure monitoring system differ from the learnt value by more than a threshold value, the system has to find out the cause for it by means of monitoring the tire natural frequency.

FIG. 1 shows a flow chart of a method according to the present invention for automatically initializing an indirectly measuring wheel speed monitoring system. In block 1 the indirectly measuring wheel speed monitoring system compares the learnt reference values connected with the rolling circumferences of the wheels with actual values. By evaluating the differences it is possible to detect a wheel with a pressure loss. By evaluating the learnt reference values, the indirectly measuring tire pressure monitoring system indicates, therefore the wheel with the presumed deflation (block 2). The tire inflation of the single tires is also monitored by evaluating the natural frequency of each single wheel (block 3). As shown in FIG. 1, this frequency analysis can be executed simultaneously respectively parallel to the monitoring of the rotational wheel movement respectively rolling circumferences (block 1 and 2) or also subsequently to the detection of a deflation by evaluating the rotational movements respectively rolling circumferences (block 2).

If the evaluation of the rotational movements respectively the rolling circumferences as well as the evaluation of the natural frequency on one and the same wheel show a deflation in comparison to the previous situation (before the standstill of the vehicle), case a) is given, i.e. a warning is emitted to the driver that a deflation has occurred.

If the evaluation of the natural frequency on the wheel, however, does not result in a lower tire pressure than before (before the standstill of the vehicle) (block 4), but e.g. one to three of the other wheels show a higher pressure than before (before the standstill of the vehicle), case b) or c) is given, i.e. an automatic initialization (auto reset) is executed in order to learn the actual states (block 5).

The signature of the wheel speed sensor of the corresponding wheel can be used as another criterion for detecting a tire change (case b). This signature is known from systems for detecting damage on the wheel and is determined in the system monitoring the torsion natural frequency. The signature depends on the manufacturing tolerances of the sensor and on the structure, the profile and the wear of the tire. Changing the tire changes also the signature of the corresponding sensor. If the signature on one or several tires changes between the parking of the vehicle (ignition off) and its restart, this may be detected by comparing the signatures memorized when parking the motor vehicle, with the actual signatures. In this case the indirectly measuring tire pressure monitoring system is also initialized again.

### REFERENCE NUMERALS

1 Analysis of the rotational movements of the wheels respectively rolling circumferences: comparison of learnt reference values with continuously detected new values
2 Analysis of the rotational movements of the wheels respectively rolling circumferences: detection of a deflation on a wheel
3 Frequency analysis: evaluation of the natural frequency of the single wheels
4 Frequency analysis: no deflation on the same wheel
5 Auto reset (automatic initialization).

1-6. (canceled)

7. A method for automatically initializing an indirectly measuring tire pressure monitoring system which due to a change of the rotational behavior of the vehicle wheels, such as a change of a rolling circumference, by means of a comparison of learned reference values with continuously detected new values (1) detects a deflation on the vehicle wheels, and where a deflation on the vehicle wheels is detected by evaluating a natural frequency of the single vehicle wheels (3), the method comprising:
executing an automatic initialization (5), if during movement of the vehicle after its standstill the indirectly measuring tire pressure monitoring system detects a deflation on a vehicle wheel with regard to the situation before the standstill of the vehicle (2) by evaluating the rotational behavior of the vehicle wheels, whereas the evaluation of the natural frequency of the vehicle wheels results in that on the same vehicle wheel no deflation prevails (4).

8. The method according to claim 7, wherein a warning is emitted to a driver if a deflation on one and the same wheel is detected by evaluating the rotational behavior of the vehicle wheels as well as by evaluating the natural frequency.

9. The method according to claim 7, wherein the automatic initialization (5) is executed on a basis of signatures of wheel speed sensors.

10. The method according to claim 7, wherein the entire indirectly measuring tire pressure monitoring system is automatically initialized.

11. The method according to claim 7, wherein only part of the indirectly measuring tire pressure monitoring system is automatically initialized which is based on the evaluation of the rotational behavior of the vehicle wheels or on the evaluation of the natural frequency of the vehicle wheels.

12. A computer program product, wherein the program defines an algorithm comprising a method according to claim 7.
